(19) United States
(12) Patent Application Publication
(10) Pub. No.: US 2006/0065089 A1
(43) Pub. Date: Mar. 30, 2006

(54) Ozonation for food slicing machine

(75) Inventor: Godfrey D. Rawes, Denbighshire (GB)

Correspondence Address: KREMBLAS, FOSTER, PHILLIPS & POLLICK, 7632 SLATE RIDGE BOULEVARD, REYNOLDSBURG, OH, 43068, US

(73) Assignee: J. E. Grote Company, Inc.

(21) Appl. No.: 10/954,538

(22) Filed: Sep. 30, 2004

(51) Int. Cl. B26F 3/00

(52) U.S. Cl. 83/177

(57) ABSTRACT

An apparatus for disinfecting food slicing machines during use, and which does not necessitate stopping the machine to clean. The apparatus generates ozonated water and directs the ozonated water onto the band blade of the machine. The ozonated water is highly antibacterial, but leaves little or no undesirable residue. The apparatus includes a first fluid circuit in which the water flows and is ozonated. A second fluid circuit is in fluid communication with the first circuit, and has an outlet, such as a nozzle, that directs ozonated water onto the band blade. Preferably, the outlet is connected to a blade guide through which the band blade extends, and thereby supplies ozonated water to where it is the most needed: at the cutting surface.

### (e) BACKGROUND OF THE INVENTION

1. Field of the Invention

This invention relates generally to food slicing machines, more particularly to an ozonation apparatus for food slicing machines, and still more particularly, an ozonation apparatus for food slicing machines that use an endless loop band blade to slice food products.

2. Description of the Related Art

It is well known to use an endless loop band blade extending around a pair of pulleys to cut food products. U.S. Pat. No. 4,230,007 to Grote et al., which is herein incorporated by reference, discloses such an apparatus. Such devices cut food by passing the food product, such as a food log, through a path that includes the upper span of the blade. As the food log passes through the blade, the blade severs a food product slice below the contact point with the blade from the food log above the contact point.

Such band blades are held in place by a blade guide, which is a thick slab of metal, such as tool steel, with a slot that is slightly thicker than the band blade. The slot extends into the blade guide at the intersection of two adjacent sides of the blade guide that intersect at an acute angle. The unsharpened edge of the blade is inserted into the slot, and the sharpened edge extends out therefrom. Because the slot has a slightly greater thickness than the blade, the blade fits into the slot with very little movement possible transverse to the plane of the blade. The food log is displaced through the sharp edge of the blade and onto the top of the blade guide, and the blade guide maintains the position of the edge of the blade despite the forces applied to the blade by the food log. There is a frictional engagement between the blade and blade guide, which is commonly lubricated by water injected into the slot of the blade guide.

Such food slicing machines can be difficult to clean due to the sharpness of the blade, the large area that the blade covers, the contact points between the blade and the pulleys, and tight tolerances between the blade and the blade guide slot. In order to effectively clean such machines conventionally, the machine is stopped, at least some parts are removed from the machine, and the entire cutting apparatus is cleaned manually.

Food safety laws mandate frequent cleaning of food slicing machines. However, cleaning of food slicing machines halts their productive activity for a significant time, thereby creating a disincentive to cleaning such machines. Nonetheless, in order to comply with requirements the operators of such machines must clean machines at least at the minimum required frequency.

It is also known that ozone, and ozonated water, has advantageous antibacterial characteristics. For example, in U.S. Pat. No. 6,132,629 to Boley and U.S. Pat. No. 6,461,487 to Andrews et al., which are herein incorporated by reference, systems are disclosed for supplying ozone to various apparatuses. Such systems have desirable properties for reducing antibacterial agents without leaving behind unacceptable levels of chemicals or other residue.

Therefore, the need exists for an apparatus for supplying ozonated water in a food slicing environment.

### (f) BRIEF SUMMARY OF THE INVENTION

### (g) BRIEF DESCRIPTION OF THE SEVERAL VIEWS OF THE DRAWINGS

FIG. 1 is a schematic view of an ozonation system that can be used as part of the present invention.

FIG. 2 is a schematic view of the preferred water inlet valve that is part of the ozonation system of FIG. 1.

FIG. 3 is a rear view of a blade guide according to the present invention.

FIG. 4 is a view in section through the lines 4-4 of FIG. 3.

FIG. 5 is a schematic plan view of the fluid lines between the ozonation apparatus and the blade guide.

FIG. 6 is a schematic rear view of the fluid lines between the ozonation apparatus and the blade guide.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### (h) DETAILED DESCRIPTION OF THE INVENTION

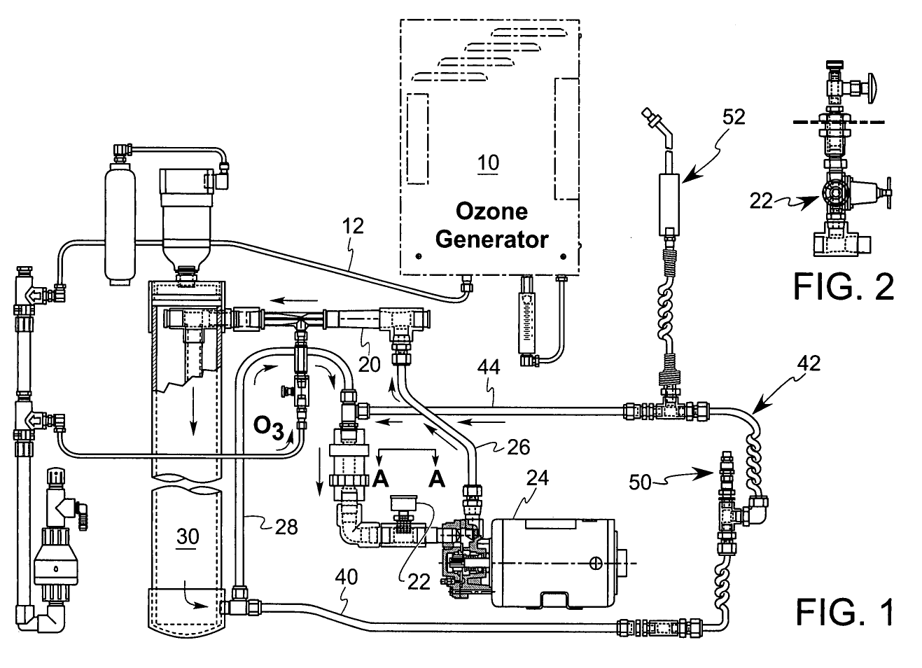

One embodiment of an ozonation apparatus is shown in FIG. 1. An ozone generator 10 is connected to a conduit 12 that extends to, and connects with, a venturi. The venturi is a conventional venturi that injects ozone gas (O₃) into the water flowing through the tube 20. Ozonated water circulates through two fluid circuits described below to provide highly ozonated water to the food-slicing machine as described herein.

The water flowing through the tube 20 enters the first fluid circuit (that contains the tube 20) at the inlet 22. In FIG. 1, the inlet 22 is mostly behind the structure designated as the inlet 22. The entire inlet 22 structure is shown in FIG. 2 from the top. Water enters through the inlet 22 and, referring again to FIG. 1, is pumped by the recirculation pump 24 into the tube 26, which connects to the tube 20. The water in the tube 20 passes through the venturi and the ozone content of the water therein is increased in a conventional manner. The water then flows into the contact chamber 30, which operates in a conventional manner, and then out into the tube 28, which directs the water back to the inlet 22 described above. Any shortage of water is made up at the inlet 22, as controlled by conventional pressure and flow rate regulators, pumps and valves.

A second fluid circuit is in fluid communication with the first fluid circuit that includes the tubes 20, 26 and 28 and the contact chamber 30 described above. This second fluid circuit includes the tubes 40, 42 and 44. A pair of outlets, such as the solenoid-actuated valve 50 and the manually actuated hand sprayer 52, remove water from the first fluid circuit in the following manner, thereby causing water to flow through the second fluid circuit.

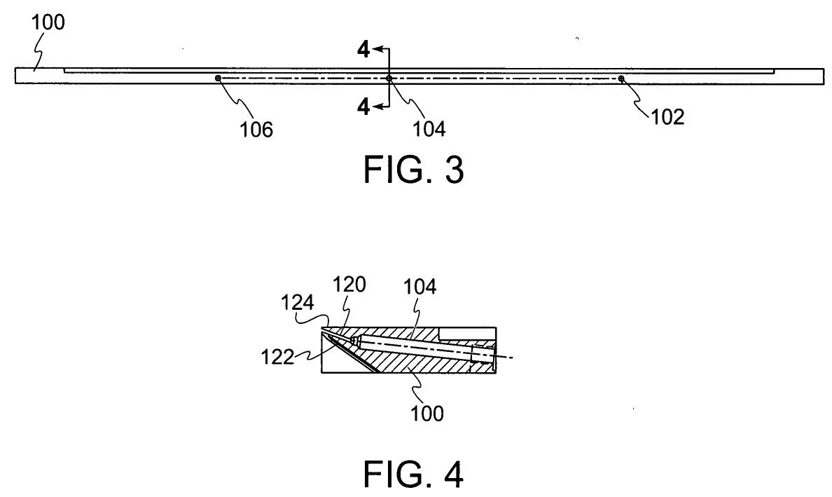

First, during normal operation of a connected food slicing machine, the solenoid-actuated valve 50 is opened to permit ozonated water in the second fluid circuit to flow to the blade guide, as described below in relation to FIGS. 3-6. The removal of this ozonated water from the second fluid circuit causes the pressure in the second fluid circuit to drop, which causes water to flow from the opening at the bottom (in FIG. 1) of the contact chamber 30 to flow into the tube 40 in addition to the tube 28. When water flows into the tube 40, which is substantially smaller in internal diameter than the tube 28, less water flows out of the contact chamber 30 into the tube 28. However, regardless of how much water is removed through the tube 40, some water is always directed from the contact chamber 30 into the tube 28.

When water flows into the tube 40, it is water that contains near the maximum concentration of ozone of the entire system, due to its proximity to the venturi 20 and contact chamber 30. Thus, this water is very capable of being transported a significant distance without most or all of the ozone therein converting, due to a long period of time elapsing, back to O₂.

When water flows into the second fluid circuit, the system adds water through the water inlet 22 to the first fluid circuit, and this water is immediately ozonated after introduction. As water continues to be removed from the first fluid circuit at the tube 40, the system continues to add water and immediately ozonates it. This water is removed into the second fluid circuit due to opening of the valve 50 during normal operation of the food slicing machine, or during use of the manual sprayer 52 during manual cleaning of the food slicing machine. Thus, at all times there is ozonated water present during circulation of water in the first fluid circuit, and there is ozonated water readily available in the second fluid circuit upon actuation of the valve 50 or manual sprayer 52. Typically, the manual sprayer 52 would be used to manually spray down a food-slicing machine when the machine is not slicing food. However, the sprayer 52 could be placed with its nozzle in close proximity to the blade to spray the blade as it is cutting.

Although the ozonation apparatus is shown in FIG. 1 having two fluid circuits, it is possible to use an ozonation apparatus having only one fluid circuit. For example, by eliminating the tubes that make up the second fluid circuit and placing the valve 50 and manual sprayer 52 in fluid communication with the first fluid circuit, a simplified ozonation apparatus can be used with a food slicing machine as described below. Furthermore, the components of the ozonation apparatus are considered to be conventional, and it will become apparent to a person having ordinary skill that a conventional substitute for each component can be made without affecting the invention except as will become apparent to a person of ordinary skill.

The valve 50 is preferably connected to the blade guide 100 of the slicing machine as shown in FIGS. 3-6. As show in FIGS. 3 and 4, the blade guide 100 preferably has a conventional structure, in which an elongated metal plate has a slot 120 formed in its side to accommodate the blade (not shown) that is inserted therein. The blade slot 120 is formed at the intersection of two edges 122 and 124 that intersect at an acute angle to permit the sliding of the food log along the top edge 124 and the “wedge” action of the slice against the lower edge 122 to displace the slice downwardly under the influence of gravity.

Three bores 102, 104 and 106 are formed in the rear edge of the blade guide 100. It is contemplated that there could be any number of bores from one to as many as are necessary to convey sufficient fluid to the blade slot 120, as will be recognized by a person having ordinary skill in the art. The bore 104, shown in the section view of FIG. 4, extends through the blade guide from the rear edge of the blade guide 100 to the blade slot 120. It is also contemplated that the bore or bores in the blade guide can extend from any side or end of the blade guide 100 into the blade slot.

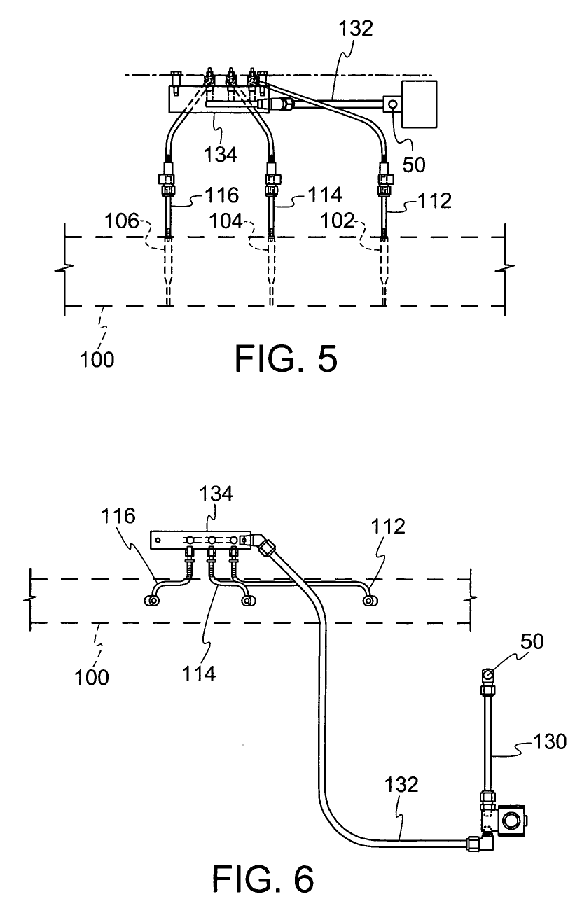

Each bore has an opening at the rear edge of the blade guide that receives a conduit, such as the tubes 112, 114 and 116 shown in FIGS. 5 and 6. These tubes 112-116 carry ozonated water from the ozonation apparatus shown in FIGS. 1 and 2 to the blade guide 100. In the embodiment of FIGS. 3-6, the valve 50 shown in FIG. 1 is in fluid communication with the tubes 130 and 132, which connect into the plenum 134 that distributes ozonated water to the tubes 112-116. Thus, the ozonation apparatus of FIG. 1 is in direct fluid communication with the blade guide 100 when the valve 50 is opened.

Upon opening of the valve 50, ozonated water flows through the respective tubes into the blade guide bores 102-106, and thereby, into the slot 120. The moving blade in the slot 120 is thereby bathed in ozonated water. This operates, in a manner understood by persons of ordinary skill, to kill bacteria that may be on the blade, blade guide, pulleys and other structures that are contacted by food products and/or the water.

Of course, the outlet, such as the valve 50, could be connected to a nozzle that simply sprays the ozonated water onto the blade. Alternatively, the water could be conveyed to the blade and its contacting structure by any other structure that causes the ozonated water released by the second fluid circuit to impinge upon the blade with flow rate and velocity that the blade is exposed to the ozonated water for a period sufficient to have the desired antibacterial effect.

As noted above, it is contemplated that virtually any water-ozonation apparatus can be used to inject ozonated water into the blade guide of a food slicing machine to construct the present invention. Thus, it will become apparent that such substitutions of other conventional water-ozonating devices is not a departure from the present invention.

While certain preferred embodiments of the present invention have been disclosed in detail, it is to be understood that various modifications may be adopted without departing from the spirit of the invention or scope of the following claims.

1. A food slicing machine having a band blade combined with an apparatus for producing ozonated water, the combination comprising:
a) a first fluid circuit through which ozonated water is circulated at a predetermined flow rate;
b) a second fluid circuit, in fluid communication with the first fluid circuit, through which ozonated water is circulated at a flow rate that is lower than flow rate of the first fluid circuit; and
c) at least one outlet in fluid communication with the second fluid circuit and with the band blade for applying ozonated water from the second fluid circuit to the band blade.

2. The combination in accordance with claim 1, wherein said at least one outlet is in fluid communication with a nozzle adjacent the band blade for directing ozonated water from the nozzle onto the band blade.

3. The combination in accordance with claim 1, wherein said band blade extends through a slot in a blade guide, and said at least one outlet is in fluid communication with the blade guide slot, for directing ozonated water from the second fluid circuit into the blade guide slot through which the band blade extends.

4. The combination in accordance with claim 3, wherein said at least one outlet is in fluid communication with a nozzle for directing ozonated water from the nozzle onto the food slicing machine.

5. A food slicing machine having a band blade combined with an apparatus for producing ozonated water, the combination comprising:
a) a fluid circuit through which ozonated water is circulated;
b) at least one outlet in fluid communication with the fluid circuit; and
c) a blade guide having a slot through which said band blade extends, and said at least one outlet is in fluid communication with said slot for directing ozonated water from the fluid circuit into the slot through which the band blade extends.

6. The combination in accordance with claim 5, wherein said at least one outlet is a valve adapted to be open when the food slicing machine is slicing a food product.
